(19) United States
(12) Patent Application Publication
(10) Pub. No.: US 2011/0006920 A1
(43) Pub. Date: Jan. 13, 2011

(54) Aircraft Approach Path Indicator

(76) Inventor: Gerard Miet Bauer, Lincolnshire (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/921,651

(22) PCT Filed: Mar. 11, 2009
(86) PCT No.: PCT/GB09/50234

§ 371 Date: Sep. 24, 2010

(30) Foreign Application Priority Data
Mar. 11, 2008 (GB) 0804462.0
May 16, 2008 (GB) 0808910.4
Jan. 7, 2009 (GB) 0900131.4

(51) Int. Cl. B64F 1/22

(52) U.S. Cl. 340/972

(57) ABSTRACT

An aircraft approach path indicator (1) including a projector unit (6) adapted to provide three discernibly different signals (11, 12, 13), wherein one of the signals (11) indicates an approach path which is too high, one of the signals (12) indicates an approach path which is too low and the other signal (13) indicates an approach path which is safe, and wherein the three discernibly different signals comprise bands of light, wherein the three different signals are generated by a first projector (6a) and a second projector (6b), wherein the first and second projectors are located in fixed relationship to each other, and wherein each projector emits light of a different colour in a band, and wherein the two bands of light emitted by the projectors overlap, and wherein in the region of the 10 overlap a third band of light of the third colour is formed.

### FIELD OF THE INVENTION

The present invention relates to approach path indicators for aircraft and in particular to an omni-directional approach path indicator.

### BACKGROUND OF THE INVENTION

For an aircraft to be able to land safely it is essential that it follows an appropriate descent angle with respect to its intended touch down point. Approach path indicators which guide an aircraft to a safe approach path are known and are typically used when landing in the dark or otherwise sub-optimal light conditions. An approach path indicator typically gives three indications to an approaching aircraft, one indicating that the aircraft is on the correct approach path, one indicating that the aircraft's approach path is too high and one indicating that the aircraft's approach path is too low. Typically, the pilot of an approaching aircraft sees the colour white when the aircraft is too high, red when the aircraft is too low and flashing red and white when the aircraft is on the correct path. Where the line of approach is known, for example at an airfield or heliport, a permanent approach path indicator forms part of the airfield/heliport's infra-structure. Such permanent approach path indicators typically provide for only one line of approach. In many scenarios aircraft are required to land at temporary airfields/heliports, for example in warfare, the delivery of humanitarian aid, or at rescue scenes.

Currently where a temporary airfield to support a military or humanitarian operation is to be established, the construction of a flight path indicator system requires a team of operatives to survey the site and subsequently construct a temporary flight path indicator. The flight path indicator typically deployed offers only a single heading, that is approaching aircraft may only approach from one angle. Aircraft must be heading into the wind upon landing, which means that in the scenario of a temporary airfield/heliport the flight path indicator must be moved if the wind changes direction, which takes considerable time and requires a team of suitably trained operatives to be on hand. The aforementioned approach path indicator uses lasers to provide the “too high”, “too low”, “on path” indications. One of the problems with this system is that the lasers emit light having a single wave length, which results in rain drops causing diffraction and diffusion of the light. This can cause the light to bend away from its true direction or cause a colour to appear in the wrong place, an indication that the aircraft is on a correct path when in fact it is too high or too low, which would obviously be highly dangerous.

It would be desirable to provide an approach path indicator which is easily portable and can quickly be deployed. Further, it would be desirable for such an approach path indicator to be able to guide in aircraft and particularly helicopters travelling on a number of different approach lines. This would provide for the landing site to be used whatever the prevailing wind, and allow for different approach lanes to be used, which is advantageous where a large number of landings are to occur.

An omni-direction approach path indicator provides the approach path indication through 360 degrees. Whilst omni-directional approach path indicators are not currently in use, a number of such devices have been described.

In U.S. Pat. No. 4,532,512 an omni-directional approach slope indicator for helicopters is described. The device is comprised of two lighting units each including two 120 volt, 1000 watt tungsten halogen lamps, each lighting unit being mounted on opposing sides of a vertically oriented rotatable shaft. One of the lighting units has a red filter, with the other emitting unfiltered light. This gives three bands of light, the upper band being white, the lower band being red, and the central band (the approach path) being flashing red and white. This device uses a continuous output of light and is a permanently fixed structure.

An omni-directional path guidance indicator is disclosed in European Patent no 0324628. It comprises a plurality of optical systems (eight in the example described), each including a light source, a mirror, a lens and a colour filter which covers half the optical aperture. A housing including windows sits over the rotating optical systems and is stationary. The optical systems rotate and provide the following signals as observed by a pilot making an approach:

i) Flashing red;

ii) continuous red;

iii) continuous white;

iv) flashing white;

v) continuous red and white;

the signal seen depending on the approach angle. It is stated that the apparatus may be modified to provide continuous signals only.

International patent application no WO 86/04437 ('437) describes an omni-directional helicopter approach path indicator. Two sets of self-powered lights are rotatably mounted on a shaft. The self-powered lights may comprise glass tubes filled with radio-active gas, such as self-luminous ISOTLITE tritium light wands. The lights are mounted about a circumference, the diameter of the lower light source being 7 to 8 feet and the upper light source 4 to 5 feet. The light sources are supported by an element extending radially from a central mount, which fits onto the upright shaft, to the lights (see FIG. 1 of '437). Height adjustment of the lighting units is by means of a crank handle and bevel gears. The effect of rotating the crank handle is to increase or decrease the distance S between the upper and lower lights. When the pilot is on the correct approach path he sees two distinct ellipses one touching the other. If the pilot is too high he sees two vertically overlapping images (see FIG. 6 of '437). If the pilot is too low he sees two vertically spaced apart ellipses (see FIG. 7 of '437).

A portable approach path indicator, which may be pulled around in the same manner as a trolley is described in U.S. Pat. No. 3,474,406.

The present invention seeks to provide an approach path indicator which in addition to providing indications of three paths, namely: too low, too high and on path, provides a secondary indication that the approach is being made on the correct path.

One aspect of the invention seeks to provide an omni-directional approach path indicator.

Another aspect of the invention seeks to provide an approach path indicator which is easily portable and can quickly be deployed.

Another aspect of the invention seeks to provide an approach path indicator which is not susceptible to condensation.

Another aspect of the invention seeks to provide an approach path indicator which may provide an approach path indication through a sector extending around a substantially vertical axis by electronic means.

Another aspect of the invention seeks to provide an arrangement for adjusting the angle of the approach path indicated.

Another aspect of the invention seeks to provide an approach path indicator including a self-leveling system.

In the present application the term “omni-directional approach path indicator” shall mean an approach path indicator capable of projecting a signal throughout or at any point in an arc extending substantially 360 degrees around a substantially vertical axis and shall include devices where the path is obscured in a small sector by items such as a stand from which part of the device is suspended.

In the present application the light resulting from superposing green light on red light is referred to as producing “white light”. The light produced may appear yellow, amber or another off-white shade. In the context of this application the term “white light” shall be understood to encompass such colour variations.

### SUMMARY OF THE INVENTION

According to one aspect of the present invention there is provided an aircraft approach path indicator as specified in Claim 1

Preferably, the third band of light is formed of a third colour created by overlapping of the bands of light emitted by the two projectors.

Preferably, the approach path indicator further includes a mounting assembly. Advantageously, the mounting assembly allows for the angle of indicated approach path to be adjusted.

Preferably, the approach path indicator further comprises a mechanism for adjusting the angle of indicated approach path. Advantageously, the projector unit is pivotally mounted in a bracket and the mechanism for adjusting the angle of the indicated approach includes an element disposed between the bracket and the projector unit to adjust the position of the projector unit with respect to the bracket. Preferably, the element disposed between the bracket and the projector unit includes a first threaded member. Advantageously, a second member correspondingly threaded is mounted on the bracket. Advantageously, rotation of one of the first and second threaded members causes the projector unit to rotate about its pivot mount.

Preferably, the projector unit is mounted on a turntable. Preferably, the speed of rotation of the turntable is between ten revolutions per minute and one hundred and eighty per minute. More preferably, the speed of rotation of the turntable is sixty revolutions per minute.

Favourably, the projector unit comprises a block of material in which are formed two substantially parallel bores, each bore forming a projector tube of one of the first and second projectors.

Alternatively, the projector unit comprises two blocks of material, each block of material including bores extending axially into the block of material. Advantageously, the respective blocks of material are attached to one another in fixed relationship.

Preferably, each projector tube includes a source of light. Advantageously, the source of light is a coloured light emitting diode (LED). Preferably, the colour of light emitted by the LED of the first projector tube is green or cyan and the colour of light emitted by the LED of the second projector tube is red. Advantageously, in the region of overlap the third band of light formed is coloured white.

Favourably, the light emitted by at least one of the projectors is a flashing light. When the light emitted by each projector is a flashing light the third band of light then includes two flashing lights of different colours.

Preferably, the light emitted by at least one of the projectors is a continuous light.

More preferably, the light emitted by one of the projectors is a flashing light and the light emitted by one of the projectors is a continuous light. Advantageously, the third band of light comprises a flashing signal of two different colours, one formed by the overlapping of the bands of light emitted by the two projectors and the other formed by the light emitted from the projector configured to emit continuous light.

Preferably, the approach path indicator further includes adjusting means for adjusting the angle of projection of light projected from a projection tube. Advantageously, the adjusting means comprises a wedge prism mounted rotatably within the projection tube.

Preferably, the projector unit is mounted on a self-leveling mechanism.

Preferably, the approach path indicator further comprises a shroud mounted on the turntable for rotation therewith. Advantageously, the shroud includes a window aligned with the projectors. More preferably, the approach path indicator further comprises a heat source located adjacent the window. Still more preferably, the heat source comprises the power supply circuit.

Preferably, the approach path indicator further comprises an obturating means. Advantageously, said obturating means is configurable to prevent emission of an approach path signal through selected angles of rotation of the turntable.

Preferably, the approach path indicator further comprises an identification system including a receiver for receiving a signal from an aircraft and an indicator. Advantageously, the indicator is activated upon receipt of pre-defined signal by the receiver. More preferably, the pre-defined signal is encoded. Advantageously, the indicator emits a signal in the form of electro-magnetic radiation. Preferably, the signal is provided by one or more of the projectors.

According to another aspect of the present invention there is provided an aircraft approach path indicator as specified in Claim 28. This particular embodiment may be used with different types of projector unit, including those which include two projectors facing in opposite directions, three projectors equi-distantly spaced about the axis of rotation, and a projector unit comprising a single source of light and three colour filters, one above the other.

Preferably, the projector is suspended from a self-leveling mechanism.

Preferably, the approach path indicator further comprises a mechanism for adjusting the angle of indicated approach path. Advantageously, the projector unit is pivotally mounted in a bracket and the mechanism includes an element disposed between the bracket and the projector unit to adjust the position of the projector unit with respect to the bracket. Advantageously, the bracket is balanced about its attachment to the self-leveling mechanism. Preferably, the projector unit is pivotally mounted in the bracket and is balanced about its pivot axis.

Preferably, the element disposed between the bracket and the projector unit includes a first threaded member. Advantageously, a second member correspondingly threaded is mounted on the bracket. Advantageously, rotation of one of the first and second threaded members causes the projector unit to rotate about its pivot mount.

Preferably, the approach path indicator further comprises biasing means arranged to exert a force upon the projector unit to cause said projector unit to rotate about its pivot mount. Advantageously, the element exerts a force on the projector unit in a direction opposite to the direction of force exerted on the projector unit by the biasing means.

Preferably, the approach path indicator further comprises a drive. Advantageously, the drive is connected to the element disposed between the bracket and the projector unit said drive being controllable to move said element to adjust the position of the projector unit with respect to the bracket. Favourably, the drive comprises a motor. More favourably, the motor is mounted on the bracket.

According to yet another aspect of the invention there is provided an aircraft approach path indicator as specified in Claim 39.

Preferably, the self-leveling and stabilisation mechanism includes a universal joint. Advantageously, the projector unit is suspended from one side of the universal joint and the other side of the universal joint is attached to a drive mechanism. This particular embodiment may be used with different types of projector unit, including those which include two projectors facing in opposite directions, three projectors equi-distantly spaced about the axis of rotation, and a projector unit comprising a single source of light and three colour filters, one above the other. A gimbal type arrangement, such as that shown in the Figures, provides the aforesaid self-leveling and stabilisation mechanism. Stabilisation is provided by the inertia of the rotating projector unit and projector unit suspension mechanism. In the event that a sideways force is exerted on the approach path indicator, for example if the approach path indicator is buffeted by an incoming aircraft, the action of the force on the projector unit will be damped by the stabilization mechanism. Similarly, when the sideways force is removed, any resulting force which would cause the projector unit to swing from side to side is similarly damped. Further, the provision of two pivot axes between the drive and the projector unit interrupts any forces acting on the projector unit likely to cause pendulum type oscillation.

According to another aspect of the invention there is provided an aircraft approach path indicator including a shroud at least a portion of which is substantially transparent, and a heater disposed in such relationship to the transparent portion as to be operable to de-mist said transparent portion. Advantageously, the heater utilizes heat generated by the electronic circuitry of the approach path indicator.

Alternative and/or preferred embodiments of the invention are set out in the claims dependent on Claims 1, 28 and/or 39, in the description and in the drawings.

The invention provides a simple and light weight approach path indicator.

The provision of two projectors which emit overlapping bands of differently coloured light allows a third band of light to be created in the region of overlap. This removes the requirement for a third projector for the creation of three signals. Also, because the light from one projector is superposed on the light of the other projector the intensity of the band of light created by the region of overlap is greater than the intensity of light from the individual projectors. Since the third band of light represents the “correct approach path” this increased intensity provides a positive reinforcement of the indication to the pilot of an aircraft being guided by the approach path indicator that he is on the correct course.

Additional projectors may be provided to emit additional signals, for example flashing light.

In the case where the light sources of the projectors are coloured light emitting diodes, the light intensity of each projector, for the same input power is greater than where the light emitted by the light sources of the projectors are white, and coloured light is achieved by filtration, since the energy associated with light other than the colour passed by the filter is lost. Hence, in the embodiment where coloured light emitting diodes are used a smaller power supply to be used.

By using high-powered light emitting diodes a range of up to twenty nautical miles may be achieved in clear conditions.

The mounting arrangement allows the angle of inclination of the indicated approach path to be adjusted very easily. In one embodiment of the invention this is achieved by mounting a weight on the body of the projector unit in a manner which permits the position of the weight on the body to be adjusted, for example by sliding the weight. In another embodiment this is achieved by a mechanism including correspondingly threaded elements. Turning one of the elements causes the projector unit to move up or down.

By forming the two projector tubes in a single block, or in two individual blocks which are attached together in fixed relationship, adjustment of the angle of inclination of the indicated approach path is simplified as adjusting the angle of inclination does not affect the relative angle between the two projectors.

Yet another advantage provided by the invention is the ability to select sectors in which the approach path indication is to be projected and sectors where it is not. This is particularly useful on temporary landing sites where obstacles in certain areas, such as trees, pylons, buildings or other landscape features are likely to be present. The approach path indicator may rotate but only operate in certain sectors, or alternatively, the turntable may be held in a fixed position directing the approach path along a safe route.

One aspect of the invention provides an approach path indicator which rotates, emitting a signal as it rotates, and hence being configured as an omni-directional approach path indicator.

Another embodiment of the invention provides the advantage that the weatherproof optical window, which protects the projector unit, can be de-misted by the action of heat released by the heat sinks of the electronics associated with the projector unit.

In one embodiment of an approach path indicator the projectors are provided with electrical power through commutator rings which allow all the components associated with the turntable to rotate therewith.

Individual components of the approach path indicators or their constructions shown in the drawings and/or described with reference thereto may in themselves form embodiments and/or preferred features of the invention.

### BRIEF DESCRIPTION OF THE DRAWINGS

In the drawings, which illustrate preferred embodiments of the invention and are by way of example:

FIG. 1 is a schematic representation of an approach path indicator according to one aspect of the invention;

FIG. 2 is a front view of the approach path indicator illustrated in FIG. 1;

FIG. 3a is a side view of the approach path indicator illustrated in FIGS. 1 and 2 adjusted to provide a first approach path;

FIG. 3b is a side view of the approach path indicator illustrated in FIGS. 1 and 2 adjusted to indicate a second approach path;

FIG. 4 is an illustration of the approach path indicator illustrated in FIG. 1 located on a sloping surface;

FIG. 5 is an illustration of the approach path indicator illustrated in FIG. 1 and provided with a shroud;

FIG. 6 is an illustration of the optical arrangement of the projectors 6a and 6b;

FIG. 7 illustrates a further embodiment of the invention including a remote operation system;

FIG. 8 is a schematic representation of the internal elements of the approach path indicator of the invention;

FIG. 9 is a schematic representation of a lamp of a projector of the approach path indicator of the invention;

FIG. 10 is a three dimensional representation of the optical arrangement illustrated in FIG. 6;

FIG. 11 is a schematic representation of the internal elements of an alternative embodiment of an approach path indicator of the invention;

FIGS. 12a to 12d illustrate the projector suspension arrangement of the embodiment illustrated in FIG. 11;

FIGS. 13a and 13b are side views of the approach path indicator illustrated in FIG. 11; and

FIG. 14 is a schematic representation of the three signals provided by an approach path indicator of the invention in which both projectors are configured to emit flashing light.

### DETAILED DESCRIPTION OF THE PREFERRED EMBODIMENTS

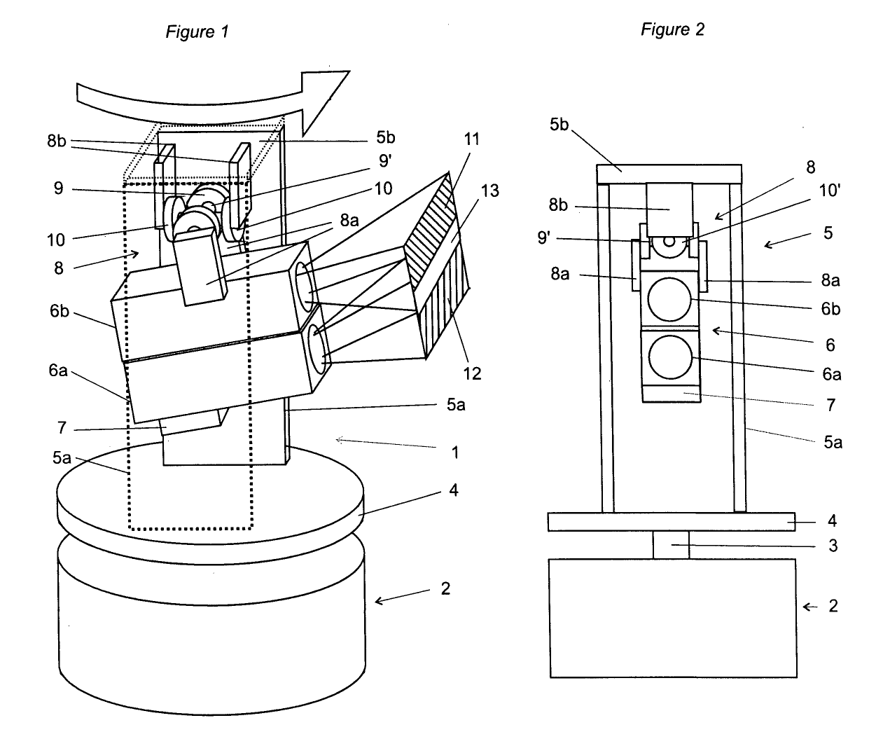

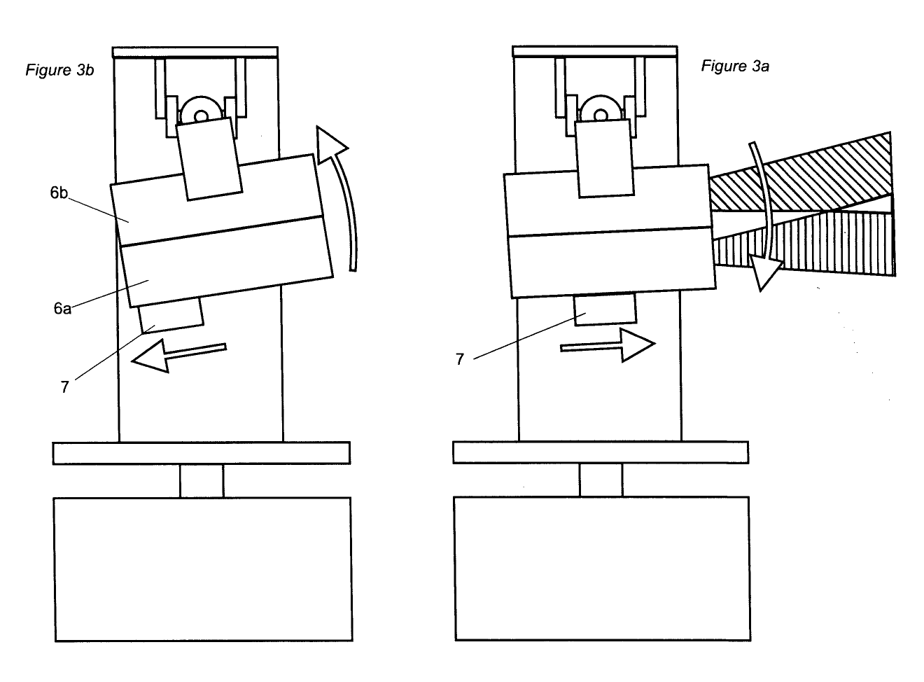

Referring now to FIG. 1, there is shown an omni-directional approach path indicator 1 which includes a base 2. A motor (not shown) is mounted within the base 2, the motor driving a shaft 3 which extends upwardly from the base 2. A turntable 4 is mounted on the free end of the shaft 3.

A projector mounting frame 5 is mounted on the turntable 4 to rotate therewith. The mounting frame 5 comprises side elements 5a and a top member 5b. Depending from the top member 5b is a projector mounting bracket 8, which includes pair of spaced apart plates 8b attached to the underside of the top member 5b and a further pair of spaced apart plates 8a lying on an axis orthogonal to the axis extending between the plates 8b. Attached to the inside of each plate 8a is a bearing 9, and to the inside of each plate 8b a bearing 10. A cross-shaped centre piece formed of a first element 9′ and second element 10′ lying perpendicular to the first element joins together the plates 8a and 8b. Respective ends of the element 9′ are located in the bearings 9 such that relative rotation between the plates 8a and the element 9′ is permitted. Respective ends of the element 10′ are located in the bearings 10 such that the relative rotation between the element 10′ and the plates 8b is permitted. The projector assembly therefore hangs freely and may orientate itself in all axes. As is described in greater detail below, adjustments to the angle of inclination of the projector unit 6 are made by changes in weight distribution thereof. The bracket arrangement described above may be replaced by another universal type joint.

It is undesirable for the projector unit to be moved off its vertical axis. Such movement could occur if the approach path indicator is knocked or buffeted. To mitigate such movement off axis damping means may be provided to damp motion of the projector unit with respect to the frame 5. Where the unit is to be rotated, separate damping means may not be required as gyroscopic forces generated by the very rotation of the projector unit serve to damp any forces acting to move the projector unit off its vertical axis. However, where the approach path indicator is configured such that the projector unit lies on a fixed heading no such gyroscopic forces will be generated and hence damping means may be included to prevent the projector unit being moved significantly off its vertical axis. Damping may be required to guard against the whole unit being disturbed by, for example, propeller wash from an incoming helicopter which may cause turbulence around the approach path indicator thereby causing it to vibrate. The provision of dampers will prevent such vibration being transmitted to the projector unit. An example of a suitable damper would be a rotary damper which may be used in conjunction with, or replace, the bearings 9, 10. However, even where the approach path indicator is configured to provide an approach path on a fixed heading, damping means need not necessarily be provided. In the event of the approach path indicator being buffeted, the fact that the projector unit may oscillate with respect to its mounting means that a force exerted on the approach path indicator need not result in a large deflection of the indicated path.

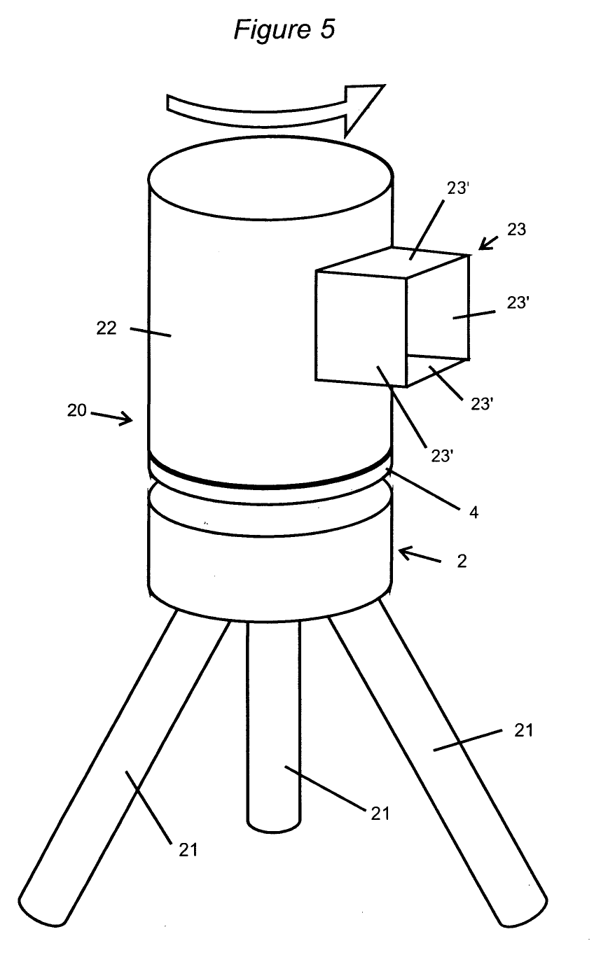

A projector unit 6 is attached between the free ends of the plates 8a. The bracket 8 provides for self-leveling of the projector unit 6 so that the projector unit is always substantially aligned with the vertical, even if the base 2 lies on a surface which is not horizontal. This is best illustrated in FIG. 4. By providing for self-leveling of the projector unit, the projector unit is provided with a degree of stabilization.

The projector unit 6 comprises a first projector 6a, which projects a first colour (red in the present example) and a second projector 6b, which projects a second colour (green or cyan in the present example). The first and second projectors are attached together so that there is relative movement therebetween. The said first and second projectors may be formed from a single block of material, such as cast aluminium, or from individual blocks of material joined together by suitable attachment means.

Where there is a requirement to provide for the indicated approach path to be matched to the terrain surrounding a landing site, or to the type of aircraft intended to land at the landing site, it is necessary to provide a means to adjust the indicated approach path. In the illustrated example it must be possible to adjust the angle of the projector unit 6 relative to the horizontal. Such adjustment is provided for by a balancing weight 7.

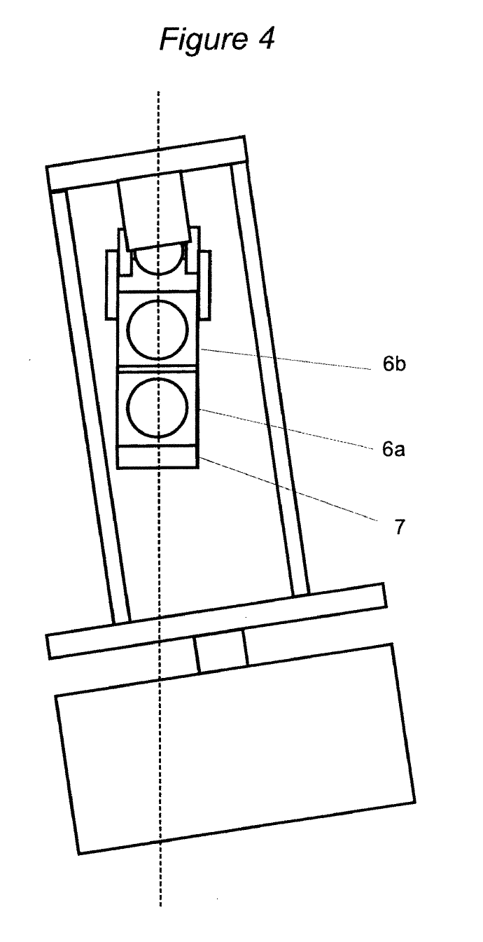

The balancing weight 7 is slidably mounted on the underside of the first projector 6a. With the balancing weight 7 being aligned with the axis of the element 10′ the projector unit will lie substantially horizontal. Sliding the weight 7 to the left increases the angle of inclination to the horizontal of the projector unit 6, and hence the angle of the projected approach path. This effect is illustrated in FIGS. 3a and 3b, where the angle of the projected approach path in FIG. 3a is shallower than that illustrated in FIG. 3b. Conversely, sliding the weight 7 to the right decreases the angle of inclination to the horizontal of the projector unit 6, and hence the angle of projected approach path.

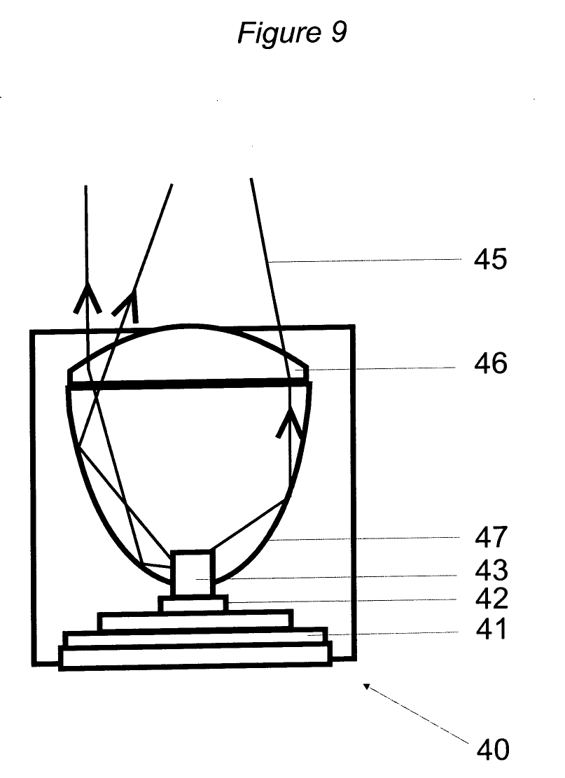

Suitable means for moving the balancing weight 7 may comprise a threaded rod mounted on the underside of the projector 6a, the rod co-operating with a correspondingly threaded element associated with the balancing weight 7. Rotation of the threaded rod may be controlled manually or by a suitable electric motor for example. As can be seen from FIG. 8, the projector unit is provided with a level sensor and display 38. The angle of projection is adjusted with the device stationary. An operator actuates a switch 39 in one direction or the other, depending on whether the angle of projection is to be raised or lowered. The shroud 22 is provided with a window aligned with the display. The operator simply observes the display and releases the switch 39 when the desired angle of projection has been attained.

The arrangement of the first and second projectors 6a and 6b as blocks which are secured together or a single block provides for simple adjustment of the angle of approach path indicated.

Referring again to FIG. 1, the approach path is indicated by three different bands of light 11, 12 and 13, as follows:

an upper green band 11, which indicates to a pilot of an aircraft approaching a landing site is following a path which is too high;

a lower red band 12, which indicates to a pilot of an aircraft approaching a landing site is following a path which is too low; and

a central white band 13, which indicates to a pilot of an aircraft approaching a landing site is following a path which is following the correct path.

With reference to the white band 13, this occupies approximately 1 degree, with the lower edge of the white band representing the desired approach path and the upper edge representing approximately 1 degree above the desired approach path.

Without departing from the invention, one or more of the projectors 6a and 6b may be arranged to provide a flashing signal. For example, the lower projector may emit a flashing red signal. This would result in a green signal representing an approach path which is “too high”, a flashing green and white signal representing an approach path which is “the correct path”, with the white signal being of greater intensity than the green signal, and a flashing red signal representing an approach path which is “too low”.

Still further, the invention is not limited to the provision of only two projectors. Third or fourth projectors may also be provided to give other indications. For example an additional projector may be added to emit a flashing light, the purpose of which is simply to attract the attention of a pilot to the presence of an approach path indicator. Alternatively or additionally, a further projector may be mounted under the projector 6a and emit a flashing red signal, to indicate to the pilot of an aircraft that the aircraft is much too low.

In the illustrated embodiment the white band is formed by the mixing of the red light projected by projector 6a with the green light projected by projector 6b, the projectors 6a and 6b being configured and arranged such that light from the said projectors 6a and 6b overlaps, thereby providing a region of white light 13. The green and red beams overlap by approximately 1 degree.

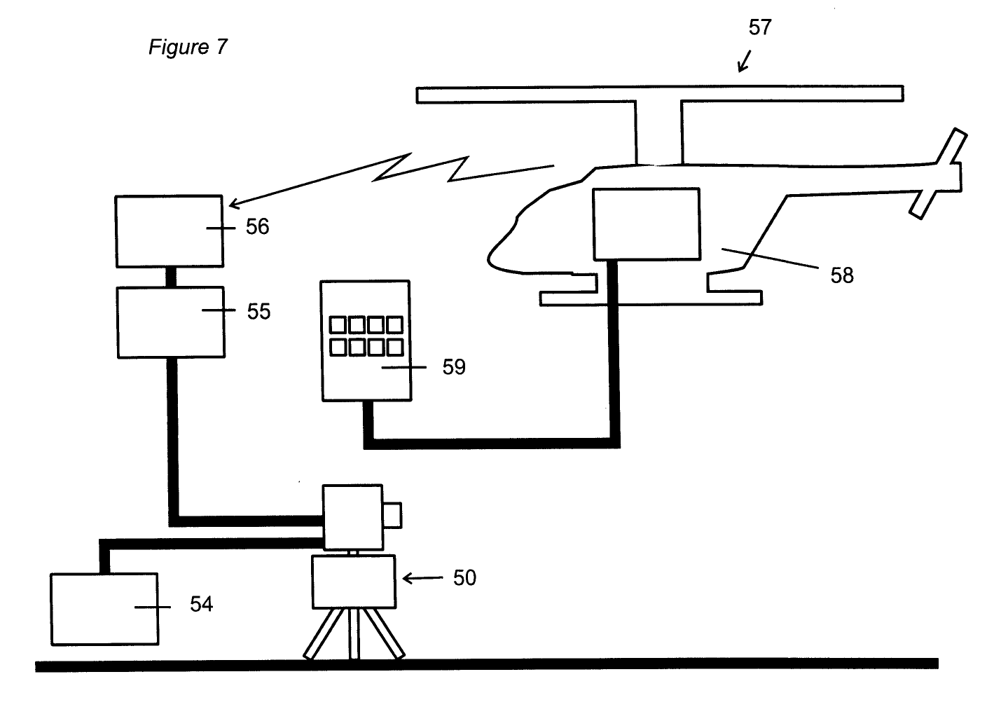

Forming the white light signal in this manner provides the advantage that only two projectors are required. Furthermore, the white light signal 13 is distinguished from the green light signal 11 and the red light signal 12 by two means. First, and most obviously, the different colour, and second, the intensity of the light of the signal 13 is greater than the intensity of either the green light signal 11 or the red light signal 12 due to the white light signal being the result of adding together the green and red light signals. For the pilot of the approaching aircraft, this reinforces the message that the aircraft is on the correct path. The nature of the light signals 11 to 13 is described in greater below with reference to FIG. 6. It should be noted that a cyan light source may be used in place of the green light source and the same result achieved.

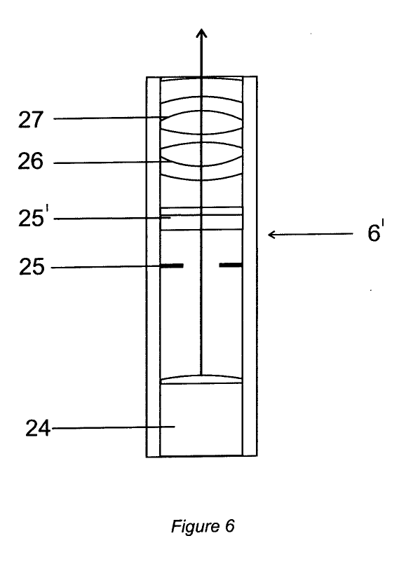

FIG. 5 illustrates the assembled approach path indicator unit 20, in which the base 2 is mounted on a tripod comprising legs 21, and the entire assembly above the base 2 rotates. As will be readily understood, the three-point mounting of the base 2 by means of the tripod ensures that there is no possibility for the unit 20 to wobble. The projector 6 is surrounded by a metal or plastic protective shroud 22 the lower edge 22′ of which sits on the turntable 4 with a shaft 3 projecting down into the base 2, which does not rotate. The base 2 contains a motor drive, which turns the shaft 3 projecting into the base 2. The shroud 22 is blacked out save for the area of the window opening 23 which is aligned with the signal output of projector unit 6. The window opening 23 may be rectangular in cross-section and is surrounded by four walls 23′, the purpose of walls 23′ being to prevent rain from impinging on the glass of the window opening 23. It is important to prevent rain drops forming on the surface of the window opening 23, as such rain drops may cause diffraction of the emitted light which may give rise to the emission of a false signal. Where the turntable 4 is rotated, providing an omni-directional signal, the speed of rotation is preferably sixty revolutions per minute meaning that a pilot following the signals emitted by the device will see a flash once each second, the colour of which corresponds to the path he is following.

FIG. 6 illustrates the optical system of the projectors 6a and 6b, the only difference between the two projectors being the colour of light emitted by each of the projectors. Each projector 6a, 6b includes a projector tube 6′ at one end of which is mounted a visible light emitter and collimator 24, a rectangular mask 25 which serves to produce the shape of image viewed by the pilot of an approaching aircraft, an optional wedge prism 25′ which when fitted is mounted rotatably in the tube 6′ and can be used to fine tune the adjustment of the angle of the beam emitted by the projector, and lenses 26 and 27 which are provided to focus the collimated light. Rotary wedge prisms are not in themselves new and are commercially available, and the mechanism which provides for rotation of the wedge prisms 25 will not be described in detail herein. Where fitted, the wedge prisms 25 are rotated during the manufacture of the projector tube 6′ until the desired angle of projection is achieved. The wedge prism 25 is then locked in place. In the present example this is achieved using grub screws and a suitable chemical locking compound, such as Threadloc™.

Where the projector tubes are made from separate components, the primary method of changing the relative angles of the projected beams to each other is a mounting capable of adjusting and locking the projectors by mechanical fasteners. The relative angle would be set in the factory and is not user adjustable. A wedge prism may be incorporated in the projector to fine tune the beam angles.

Where the projector tubes are made from a single piece of metal, the primary method of changing the relative angles of the projected beams to each other is the rotating wedge prism in each projector tube's optical system. Also, whilst it would be within the scope of the invention to provide a projector tube in which the wedge prism may be rotated by the end user, this would require precise measurement of the projection angle post adjustment which would be difficult in the field and hence it is not envisaged that end users would have access to the wedge prism.

In the present example the source of light in each projector 6a and 6b is a coloured light emitting diode (LED). The advantage of this system over systems of the prior art is that the coloured light is obtained at the point of emission rather than by filtration of white light produced for instance by an incandescent source. Where colour is obtained by filtering, the intensity of light associated with colours of light filtered out is lost, resulting in the emitted coloured light having a much lower intensity than the intensity of the white light source. Hence, for the same power input to the light source, the intensity of coloured light is greater where coloured LED's are used than where a white light source is used and colour obtained by filtering. By reducing the power requirement of the light sources the size of the power source for the unit can be reduced. Further, the size of each projector may also be reduced. This is important for where the approach path indicator is portable. The coloured LED's may be LUXEON™ or similar high powered LED's.

In the Figures the projectors 6a and 6b are mounted one on top of the other. However, the projectors 6a and 6b could be mounted side by side. In terms of what is seen by the pilot of an aircraft following the path indicated by the device of the invention, a slight lateral offset of the green and red signals does not noticeably affect the signal perceived by the pilot as the red and green signals resolve at distance so the images appear to be aligned. Nevertheless, it is preferable to mount the projectors 6a, 6b one beneath the other as the self-leveling effect is better than where the projectors 6a, 6b are mounted side by side. This is because the centre of mass of the projector unit formed of projectors mounted one below the other is lower than where the projectors of the unit are mounted side by side and further from the point of suspension of the projector unit 6. Hence, the force required to move the projector unit by a distance x away from the vertical axis is greater for the projector unit where the projectors are mounted one below the other than where they are mounted side by side.

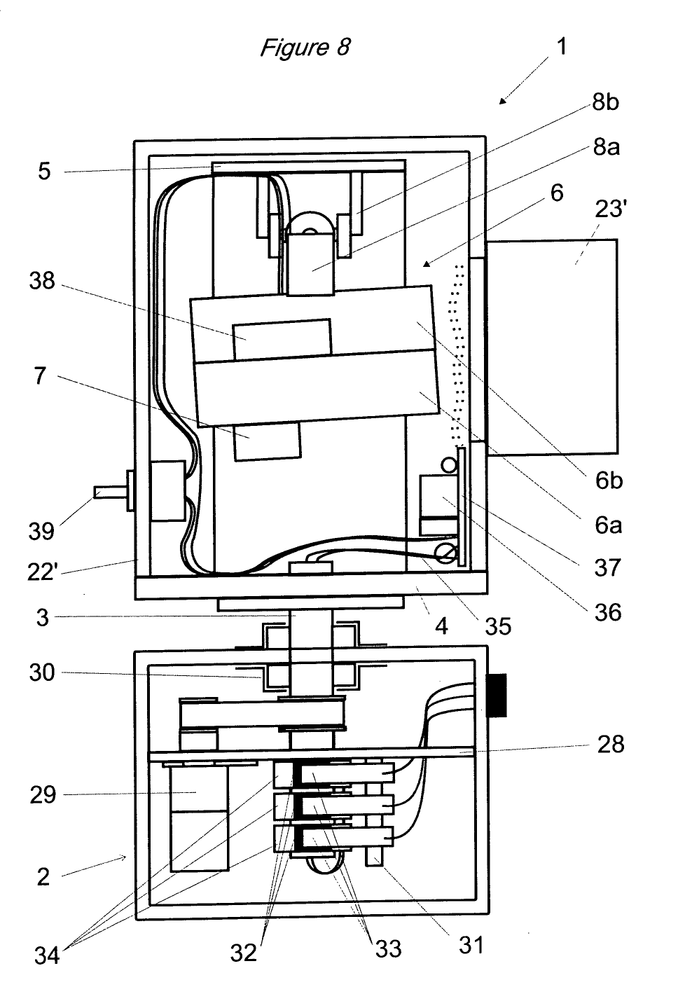

Referring now to FIG. 7, there is illustrated an approach path indicator which is remotely activated using an aircraft's radio transmitter. An approach path indicator unit 50 is located on the ground. To the unit 50 is attached a battery 54, a DTMF decoder 55 and a radio receiver 56. An aircraft 57 is provided with a radio transmitter 58, which forms part of the aircraft's standard equipment. Connected to this and mounted in the cockpit of the aircraft 57 is a remote control DTMF keypad. The keypad 59 is self-powered and marked with instructions for use of the approach path indicator. The keypad 59 allows the pilot to send a radio frequency signal from the aircraft's radio transmitter 58 to control the unit 50, for example switch on/off the visible light sources. The key pad 59 generates tone (DTMF) signals similar to those used by telephone systems. The DTMF signals are fed into the audio circuit of the aircraft's radio transmitter via jack sockets. The aircraft's transmitter is tuned into the frequency of the unit 50's radio receiver 56. The decoder 55 decodes the tones as instructions for the unit 50. Also included in the signal may be an identification facility which allows the indications emitted by the approach path indicator 50 to be distinguished easily from other light sources in the vicinity. The aircraft radio transmitter 58 transmits a signal to the radio receiver 56, which when decoded causes the unit 50 to emit a signal identifying the said unit 50. For example, the identification signal could cause a strobe light to be illuminated, or could switch off the projector unit for a few seconds before re-starting it.

The approach path indicator of the invention is advantageously portable, and when so configured is particularly suited to deployment at improvised landing sites. Such sites are often surrounded by obstacles which would not be known to pilots of incoming aircraft. Therefore, in addition to indicating the correct angle of approach (angle of descent) it is desirable that the device of the invention may be configured to emit the signals only in those areas free of obstacles. This can be achieved by providing some form of obturation means which prevents light being emitted through a desired sector, such means being either mechanical or electrical. In the case of a mechanical obturator, this may be susceptible to prop wash from helicopters flying in the vicinity of the device. Therefore, electronic obturation is preferred. Electronic obturation is provided by switches which interrupt the supply of electric current through the commutator rings (described in greater detail below) through selected angles of rotation of the turntable to switch on an off power to the projectors. Where obturation means are provided, the approach path indicator functions substantially as an omni-directional approach path indicator, save that no signal is emitted along paths which include hazards.

Further, in order to facilitate mapping of obstacles, the device may be provided with a manually operable inching function, which allows an operator to inch the turntable 2 around and set the angles through which power to the projectors 6a and 6b is switched on and off.

It is important that optical devices do not suffer from misting. The present invention provides a de-misting system comprising a source of heat. The heat dissipated by the heat sinks associated with the electronics of the projector tubes is used to raise the temperature within the shroud 22 proximate the window opening 23.

Referring now to FIG. 8, in the base 2 there is mounted a plate 28 which mounts a motor 29. The shaft 3 is mounted in a bearing 30 which is itself mounted in a wall of the base 2. The shaft 3 passes through the plate 29. Extending downwardly from the plate 29 is a brush mount 31 upon which are mounted three brushes 32 by means of spring elements 33. The brushes 32 are aligned with, and due to the force exerted by the springs 33 are in constant engagement with, three spaced apart commutator rings 34. The commutator rings 34 are fixed to the shaft 3 and rotate therewith. Electrical power is delivered from the commutator rings 34 to the power supply circuit 36 of the lamps 6a and 6b by a cable 35.

It will be noted that the power supply circuit 36 is located remotely from the projectors 6a and 6b. Locating the power supply circuit remotely from the projectors 6a and 6b allows the heat produced by the circuit to be used to advantage (the light emitting diodes of the projectors 6a and 6b require a stable input current demanding a number of electronic devices which produce a significant amount of heat). It is important that the window 23 should not become misted, which could arise due to condensation. It is possible to mount a special resistor in proximity to the window 23. However, since the circuit 36 produces significant waste heat, the overall power consumption of the device can be reduced if instead of a dedicated heat source being provided, the circuit 36 is configured in such a way that the heat evolved therefrom can be used to demist the window 23. To this end, the circuit 36 includes a heat sink 37 comprising a plate which is mounted beneath the window 23. The heat sink 37 heats the surrounding air which then rises, heating the air in the region of the window 23, thereby de-misting the window.

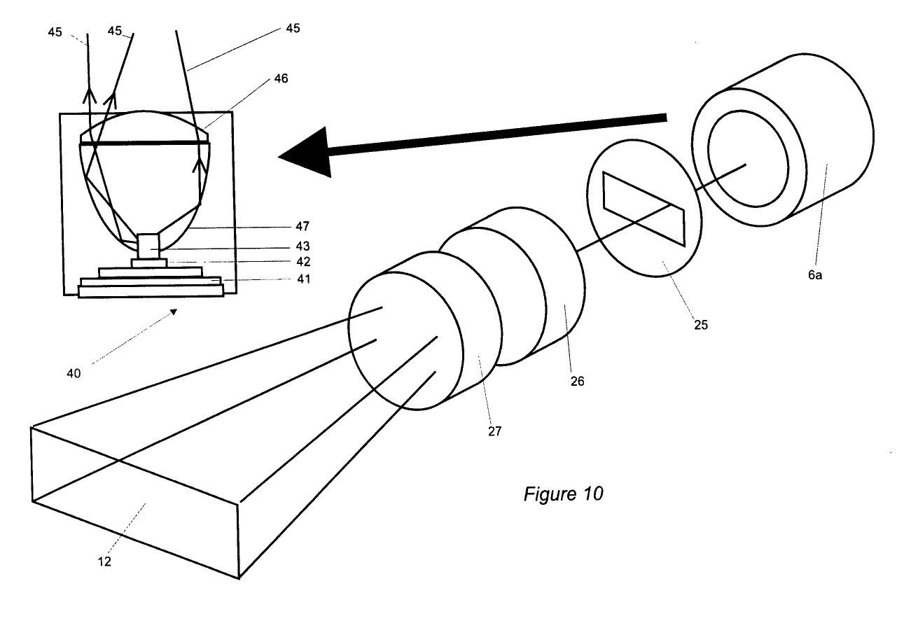

Referring now to FIG. 9, there is shown a lamp 40 which comprises a mounting plate 41 upon which an LED electrical connector 42 is secured. An LED 43 is secured in the connector 42 and when energized emits light 45. By surrounding the LED 43 with a parabolic mirror 44 light 45 is directed towards a condenser lens 46. The desired focus of light 45 is achieved by the projection lenses 26, 27 (see FIG. 6 and the description relating thereto).

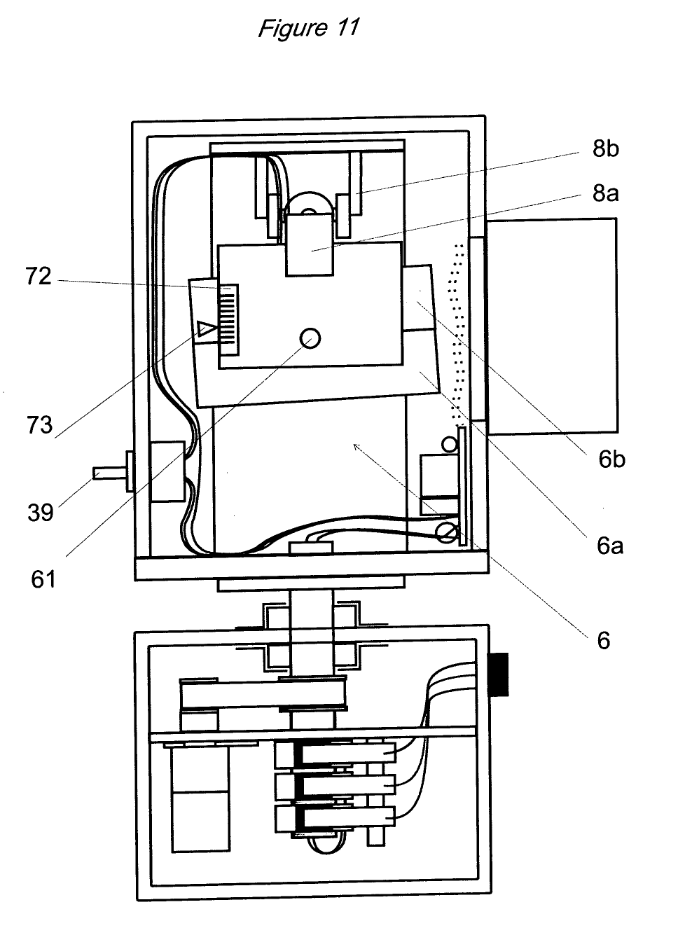

FIG. 10 illustrates the optical arrangement of the projector tubes. It is important that the images seen by the pilot of an incoming aircraft using the approach path indicator 1 are level. This is achieved by rotating the mask 25. This is done during assembly of the projector tube. Once the desired orientation of the mask 25 has been achieved the mask is locked in position by means of a grub screw or another suitable locking means, for example an adhesive known as THREADLOC™.

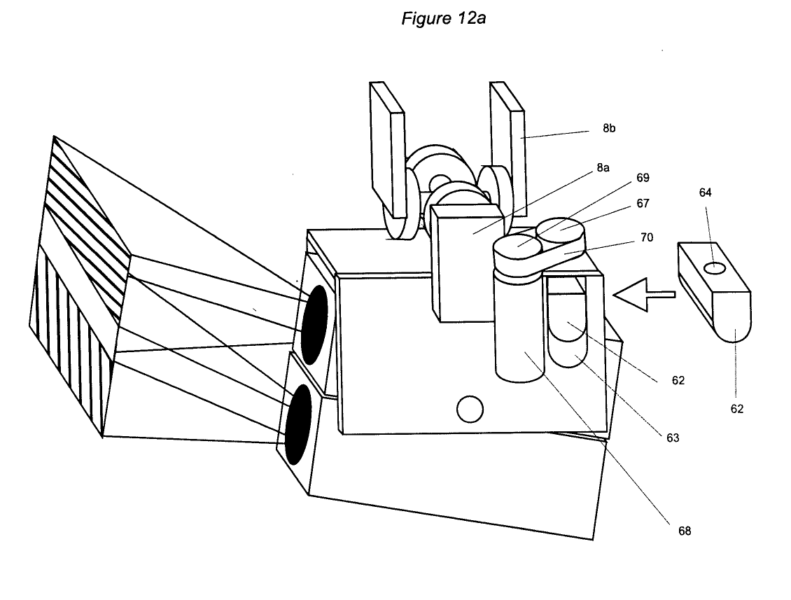

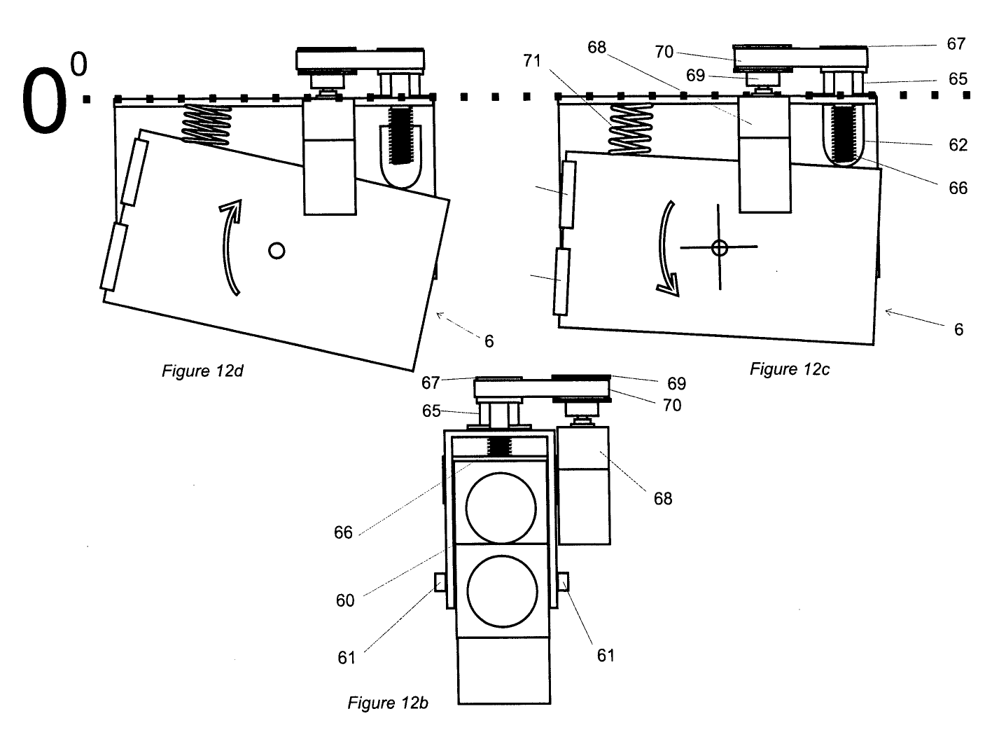

Referring now to FIGS. 11 to 13, there is shown an alternative embodiment of the invention which includes an alternative mechanism for adjusting the angle of projection of the signal in relation to the horizontal and a self-leveling system. Where the components in the embodiment illustrated correspond to the components in embodiments illustrated in other figures the same reference numerals are used and the components are not necessarily described again in detail.

The projector unit 6 is suspended in a bracket 60, which in cross-section has the shape of an inverted “U”, on pivot mounts 61 which each extend through a side of the bracket 60 into the body of one of the projectors 6a, 6b. The bracket 60 is and the plates 8a are balance such that the bracket 60 always takes up position in which it lies both horizontal and vertical. The projector unit 6 is configured such that it is balanced about the pivot mounts 61 so that rotation of the projector unit about the vertical axis does not result in the bracket 60 shifting. A mechanism is provided to adjust the angle of inclination of the projector unit 6 to the horizontal. The mechanism comprises a bar 62 which is slidably mounted in openings 63 in the walls of the bracket 60. The bar 62 includes a threaded bore 64 in its upper surface. A bolt 65 is mounted in the upper wall of the bracket 60 such that it is rotatable therein. The part of the bolt 65 extending below the said wall is threaded externally 66, the said threads co-operating with the threaded bore 64. Also attached to the bolt 65 is a pulley wheel 67. A motor 68 is attached to a wall of the bracket 60, its output shaft being equipped with a pulley wheel 69. A belt 70 extends between the pulley wheels 67 and 69 to transmit rotary motion from the motor 68 to the bolt 65. The bolt 65 is mounted in the bracket 60 such that it may turn about its own axis but may not move in a direction perpendicular to the bracket 60. Hence, when the bolt 65 is turned by the motor 68 the effect is to move the bar up or down within the bounds of the openings 63. The mechanism for adjusting the angle of inclination of the projector unit 6 to the horizontal also includes a biasing means, which in the present example is a spring 71 which is attached to underside of the upper wall of the bracket 60. The spring 71 exerts a force on the projector unit to cause movement thereof in an anti-clockwise direction. The action of the bar 62 is to exert a force on the projector unit 6 to cause movement thereof in a clockwise direction. The force exerted by bar 62, by virtue of the motor 68 is sufficient to overcome the force exerted by the spring 71 and hence the projector unit 6 takes up the angle of inclination to the horizontal as set by the position of the bar 62 relative to the bracket 60.

As indicated in FIG. 11, the motor 68 is operated by the switch 39. A level indicator comprises an indicia 72 and a marker 73 in the shape of an arrow. The projector unit 6 is raised or lowered by actuating the switch 39 in one direction or the other. As the projector unit 6 moves so the position of the marker 73 moves with respect to the indicia 72. The indicia 72 may be provided with a numeric indication of the angle of inclination, or the operator may be provided with instructions as to the angle of inclination corresponding to each graduation of the indicia 72. The angle of projection is adjusted with the device stationary.

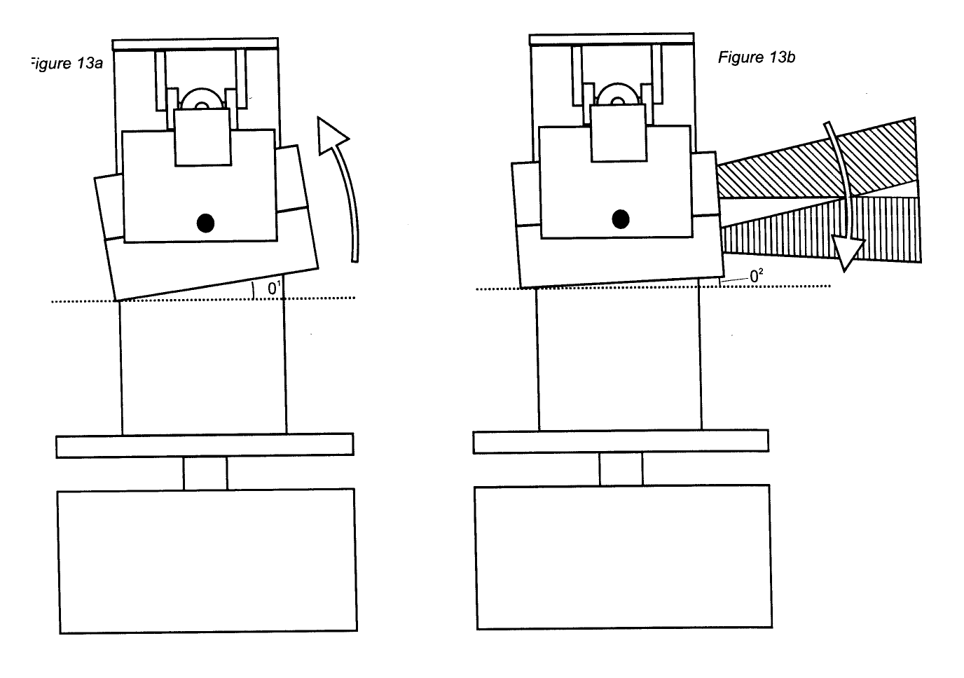

Referring to FIGS. 13a and 13b, in FIG. 13a the angle of inclination of the projector unit 6 to the horizontal is θ¹, whereas in FIG. 13b the angle of inclination of the projector unit 6 has been reduced to θ².

The mechanism for adjusting the angle of projection of the signal in relation to the horizontal illustrated in FIGS. 11 to 13b may be used with types of projector other than that illustrated in FIGS. 11 to 13b.

The approach path indicator of the invention may be configured to provide an approach path along a fixed heading. One way in which a signal on a fixed desired heading may be provided by rotating the turntable until the projectors are aligned with the desired heading and then ceasing rotation of the motor. Further, a locking means may be provided to hold the turntable in a desired position.

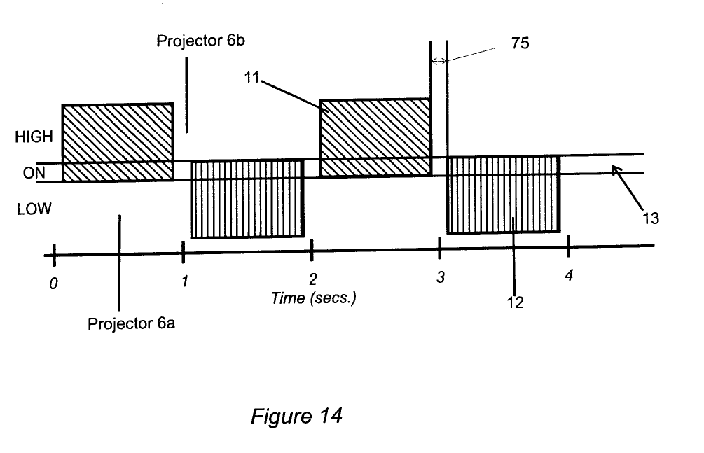

Referring now to FIG. 14, both the lower and upper projectors 6a, 6b are configured to emit flashing signals. The lower projector emits a pulse of red light for a period of ¾ second every two seconds. The upper projector emits a pulse of green light for a period of ¾ second every two seconds, with the lower and upper projectors being de-synchronised by exactly one second. The effect is as illustrated in FIG. 14, i.e. slowly flashing red light indicating the “too high” path, fast flashing red and green separated by a short dark section indicating “the correct path”, and slowly flashing green light indicating the “too low” path. Separating the red and green signals in the band 13 by a short period of darkness 75 emphasizes the pulses of green and red light.

In each of the embodiments described above, the band of light 13 is formed by part of the light emitted by the upper and lower projectors lying in the same region, which is used to either form light of a different colour as a result of colour mixing, or pulsed lights of different colours.

1-42. (canceled)

43. An aircraft approach path indicator comprising:
a projector unit adapted to provide at least three discernibly different signals, wherein one of the signals indicates an approach path which is too high, one of the signals indicates an approach path which is too low, and one of the signals indicates an approach path which is safe, and wherein the discernibly different signals comprise bands of light,
wherein the three discernibly different signals are generated by a first projector and a second projector, wherein the first and second projectors are arranged in fixed relationship to each other, and wherein each projector emits light of a different color in a band, and wherein the two bands of light emitted by the projectors overlap, and wherein in the region of the overlap, a third band of light is formed, wherein
the safe approach path is indicated by the third band of light and the first and second bands of light indicate the too low and too high approach paths.

44. An approach path indicator according to claim 43, wherein the third band of light is formed of a third color created by overlapping of the bands of light emitted by the two projectors.

45. An approach path indicator according to claim 43, further including a mounting assembly, wherein the mounting assembly allows for the angle of indicated approach path to be adjusted.

46. An approach path indicator according to claim 43, further including means to adjust the position of the projector unit relative to the horizontal.

47. An aircraft approach path indicator according to claim 43, wherein the projector unit comprises a block of material in which are formed two substantially parallel bores, each bore forming a projector tube of one of the first and second projectors.

48. An aircraft approach path indicator according to claim 43, wherein the projector unit comprises two blocks of material, each block of material including bores extending axially into the block of material, and wherein the respective blocks of material are attached to one another in fixed relationship.

49. An aircraft approach path indicator according to claim 43, wherein each of the first and second projectors includes a source of light, and wherein the source of light is a colored light emitting diode (LED).

50. An aircraft approach path indicator according to claim 49, wherein the color of light emitted by the LED of the first projector tube is one of green and cyan and the color of light emitted by the LED of the second projector tube is red, and wherein in the region of overlap the third band of light formed is colored white.

51. An aircraft approach path indicator according to claim 43, wherein the light emitted by at least one of the first and second projectors is a flashing light.

52. An aircraft approach path indicator according to claim 43, wherein the light emitted by at least one of the first and second projectors is a continuous light.

53. An approach path indicator according to claim 43, wherein the light emitted by each of the first and second projectors is a flashing light and the third band of light includes two flashing lights of different colors.

54. An approach path indicator according to claim 43, wherein the light emitted by at least one of the first and second projectors is a flashing light, and wherein the third band of light comprises a flashing signal of two different colors, one formed by the overlapping of the bands of light emitted by the two projectors and the other formed by the light emitted from the projector configured to emit continuous light.

55. An aircraft approach path indicator according to claim 43, further including adjusting means for adjusting the angle of projection of light projected from a projection tube.

56. An aircraft approach path indicator according to claim 55, wherein the adjusting means comprises a wedge prism mounted rotatably within the projection tube.

57. An aircraft approach path indicator according to claim 43, further including an identification system including a receiver for receiving a signal from an aircraft and an indicator, wherein upon receipt of pre-defined signal by the receiver the indicator is activated.

58. An aircraft approach path indicator according to claim 57, wherein the pre-defined signal is encoded.

59. An aircraft approach path indicator according to claim 57, wherein the indicator emits a signal in the form of electro-magnetic radiation.

60. An aircraft approach path indicator according to claim 57, wherein the pre-defined signal is provided by one of the projectors.
